(19) United States
(12) Patent Application Publication
(10) Pub. No.: US 2001/0056489 A1
(43) Pub. Date: Dec. 27, 2001

(54) Regional information distribution system capable of distributing advertising information elaborately at a real-time and method of distributing the same

(76) Inventor: Kenichi Ariga, Tokyo (JP)

Correspondence Address: OSTROLENK FABER GERB & SOFFEN, 1180 AVENUE OF THE AMERICAS, NEW YORK, NY, 100368403

(21) Appl. No.: 09/885,519

(22) Filed: Jun. 20, 2001

(30) Foreign Application Priority Data
Jun. 20, 2000 (JP) 184022/2000

(51) Int. Cl. G06F 15/173; G06F 17/60

(52) U.S. Cl. 709/225; 705/26

(57) ABSTRACT

The regional information distribution system has an information input terminal for fabricating advertising data with a distribution region designated thereby, a concentrated management server which is connected to the information input terminal through a communication network and which manages the advertising data, a regional distribution server which is connected to the concentrated management server through the communication network and which is integrated with a radio base station located in each region where the advertising data is distributed. The regional distribution server distributes the advertising data to a handy terminal positioned within an area of the radio base station.

### BACKGROUND OF THE INVENTION

The present invention relates to a regional information distributing system and a method of distributing regional information, in particular to such a system and a method which are capable of providing information of sale at a low price, and the like in a retail shop at a specific region.

Conventionally, insertion folders in a newspaper, as a first prior art, has been generally considered as such a regional information distributing system. In a method of using the insertion folders in a newspaper, at first, a retail shop makes a request for the insertion folders to an advertising division in a newspaper office or a professional advertising agent, several days before the insertion folders are included in the newspaper. Next, the advertising division in the newspaper office or the professional advertising agent decides contents, design, or the like of the insertion folders upon deliberation with the retail shop and presses the decided ones thereof. At last, the newspaper office inserts the pressed insertion folders into the newspaper and delivers the pressed insertion folders to homes of consumers together with the newspaper.

However, in the first prior art mentioned above, it takes several days for consumers to obtain the insertion folders. It is inevitably caused to occur that the conventional regional information distribution system cannot inform the consumers of real-time information, such as time services, or the like. In other words, the conventional regional information distribution system cannot inform the consumers just now of information to be wanted to be known to the consumers soon. Accordingly, the conventional regional information distribution system is liable to miss the consumers who have a desire to buy. Furthermore, it is impossible to send the advertising information to consumers who are not reading the newspaper.

On the other hand, another method for solving problems in the first prior art, an information service through handy-phones using radio communication has been recently proposed, as a second prior art. In the information service of the second prior art, once advertising information is input into a server, consumers can obtain the advertising information by accessing the server.

In the information service through handy-phones using radio communication of the second prior art mentioned above, it is indeed possible to provide the advertising information to the consumers at real-time. Another problem is, however, caused to occur in the information service through handy-phones using radio communication of the second prior art. Namely, it is so difficult to provide the advertising information elaborately per each region, because the advertising information is sent only from the single server.

### SUMMARY OF THE INVENTION

It is therefore an object of the present invention to provide a regional information distribution system capable of distributing the advertising information elaborately per each region to consumers at a real-time, and a method of distributing the same.

Other objects of the present invention will become clear as the description proceeds.

According to an aspect of the present invention, there is provided a regional information distribution system for use in distributing regional information to consumers through a communication network, said system comprising: an information input terminal for making advertising data designating regions where said advertising data are distributed; a concentrated management server which is connected with said information input terminal through said communication network and which manages said advertising data; and a regional distribution server which is connected with said concentrated management server through said communication network and which is integrated with a radio base station located per each region where said advertising data are distributed and which distributes said advertising data to a handy terminal existing within the area of said radio base station.

Date, time, and period for distributing said advertising data may be added to said advertising data.

The information input terminal may be located in a shop which requests distribution of said advertising data.

Information of position of said shop may be linked to said regional distribution server.

The handy terminal may have information filter function for determining favorable conditions of said advertising data for an owner of said handy terminal.

The regional distribution server may distribute only a part of said advertising data to said handy terminal, said part of said advertising data complying with said favorable conditions determined by said information filter function.

The regional information distribution system may further comprise a support server for distributing said advertising data in place of said regional distribution server when load is concentrated on said regional distribution server.

According to another aspect of the present invention, there is provided a method of distributing regional information for use in distributing regional information to consumers through a communication network, said method comprising the steps of: making advertising data including designated regions where said advertising data are distributed; transmitting said advertising data to a concentrated management server through said communication network, transmitting said advertising data to a regional distribution server which is located within said designated regions where said advertising data are distributed; and distributing said advertising data to a handy terminal existing within an area of a radio base station integrated with said regional distribution server.

Date, time, and period for distributing said advertising data may be added to said advertising data.

The advertising data may be made in a shop which requests distribution of said advertising data.

Information of position of said shop may be linked to said regional distribution server.

The method of distributing regional information may further comprise the steps of: determining favorable conditions of said advertising data by said handy terminal for an owner of said handy terminal; and distributing only a part of said advertising data to said handy terminal, said part of said advertising data complying with said favorable conditions.

The method of distributing regional information may further comprise the step of: distributing said advertising data by a support server in place of said regional distribution server, when load is concentrated on said regional distribution server.

### BRIEF DESCRIPTION OF THE DRAWINGS

FIG. 1 is a schematic view for showing a constitution of a regional information distribution system according to a first embodiment of the present invention;

FIG. 2 is a schematic view for explaining a flow of money in the regional information distribution system according to the first embodiment of the present invention;

FIG. 3 is a schematic view for explaining an operation of the regional information distribution system according to the first embodiment of the present invention;

FIG. 4 is a flow chart for explaining an operation of the regional information distribution system according to the first embodiment of the present invention;

FIG. 5 is a flow chart for explaining an operation of a regional information distribution system according to a second embodiment of the present invention:

FIG. 6 is a schematic view for showing a constitution of a regional information distribution system according to a third embodiment of the present invention;

FIG. 7 is a flow chart for explaining an operation of the regional information distribution system according to the third embodiment of the present invention;

FIG. 8 is a schematic view for showing a constitution of a regional information distribution system according to a fourth embodiment of the present invention; and

FIG. 9 is a schematic view for explaining an operation of the regional information distribution system according to the fourth embodiment of the present invention.

### DETAILED DESCRIPTION OF THE PREFERRED EMBODIMENTS

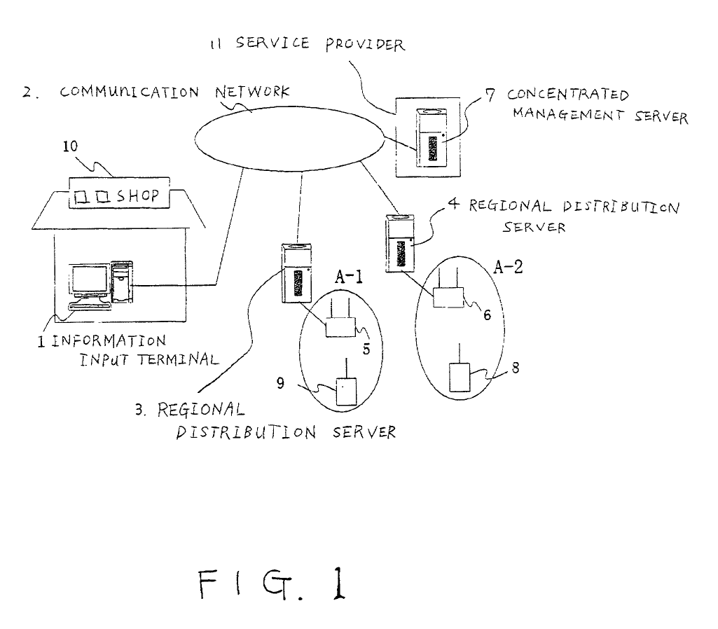

Referring now to FIGS. 1 through 4, description will proceed to a regional information distribution system according to a first embodiment of the present invention. FIG. 1 is a schematic view for showing a constitution of the regional information distribution system according to the first embodiment of the present invention. The regional information distribution system is for use in distributing regional information to consumers through a communication network.

As illustrated in FIG. 1, the regional information distribution system according to the first embodiment of the present invention comprises an information input terminal 1, a communication network 2, regional distribution servers 3 and 4, radio base stations 5 and 6, a concentrated management server 7, and handy terminals 8 and 9.

The information input terminal 1 is composed of an information processing apparatus, such as a personal computer, or the like. The information input terminal 1 has a function to make advertising data to be distributed. The information input terminal 1 is capable of making the advertising data by the use of a template supplied from a service provider 11.

The communication network 2 is composed of a communication network, such as a general telephone network, an Internet, or the like. The information input terminal 1 has another function to be connected to the concentrated management server 7 through the communication network 2 and to make the advertising data be up-loaded to the concentrated management server 7. The regional distribution servers 3 and 4 are such servers as storing information to be distributed in each region. The concentrated management server 7 transfers the advertising data up-loaded from a plurality of information input terminals 1 to the regional distribution servers 3 and 4 each located within a region where the advertising data must be distributed.

The radio base stations 5 and 6 are such ones as each having a service area of a small region, similarly to a base station used in a network like, for example, an independent communication or communication between child-phones of PHS(Personal Handy-phone System). The radio base stations 5, 6 are integrated with the regional distribution servers 3, 4, respectively.

The handy terminals 8, 9 have functions to be connected to the radio base stations 5, 6 in each region, respectively, and to selectively receive information distributed therefrom. Reception of information from the radio base stations 5, 6 is carried out by a method different from an usual public service.

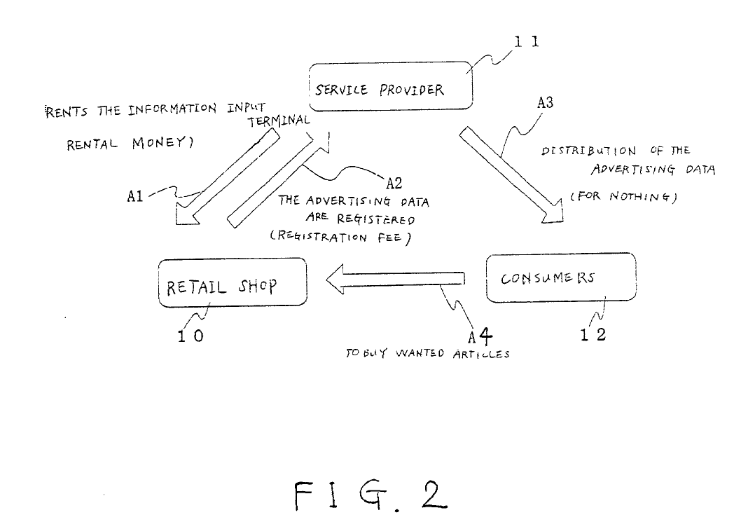

Referring to FIG. 2 with reference to FIG. 1 continued, description proceeds to a flow of money in the regional information distribution system according to the first embodiment of the present invention. FIG. 2 is a schematic view for explaining the flow of money in the regional information distribution system.

As illustrated in FIG. 2, the service provider 11 rents the information input terminal 1 to a retail shop 10 which hopes a distribution of advertisement (Step A1). The retail shop 10 then pays rental money to the service provider 11. The retail shop 10 makes the advertising data by the use of the information input terminal 1, so that the advertising data are registered on the concentrated management server 7 owned by the service provider 11. When the advertising data are registered, the retail shop 10 is charged with a registration fee determined by distribution conditions (Step A2). The service provider 11 carries out distribution of the advertising data for nothing from the regional distribution servers 3 and 4 each located in a designated region (Step A3). Consumers 12 sees the advertising data distributed for nothing to buy wanted articles on the retail shop 10 (Step A4).

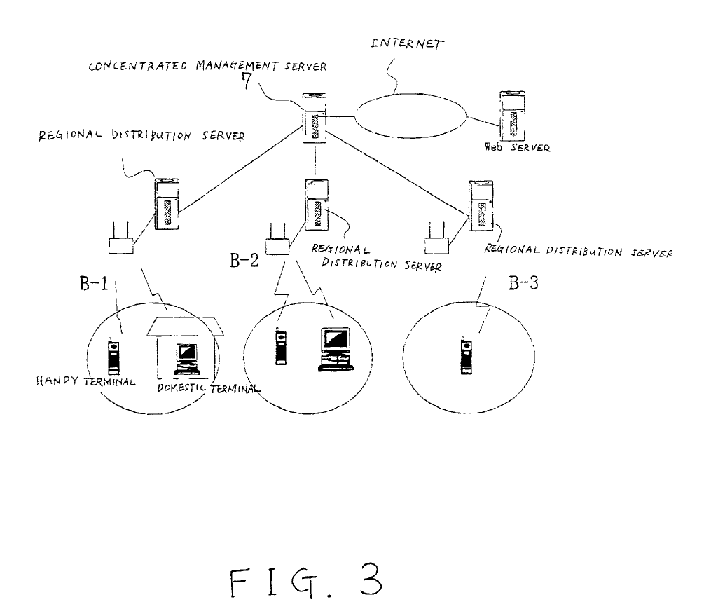

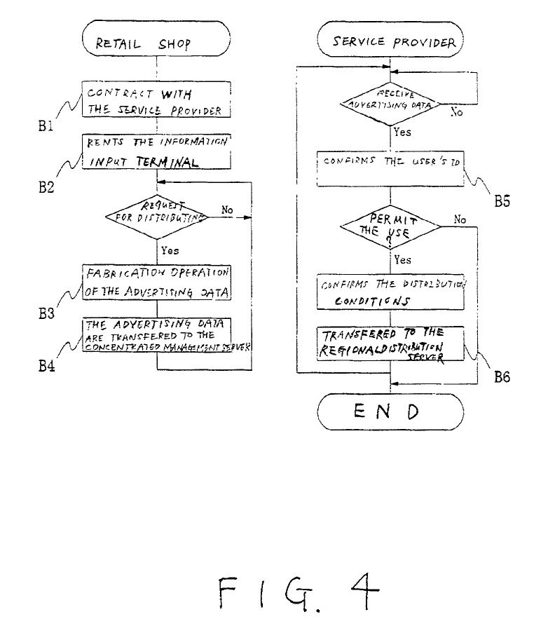

Next, referring to FIGS. 3 and 4 with reference to FIG. 1 continued, a detailed description is made about an operation of the regional information distribution system according to the first embodiment of the present invention. FIG. 3 is a schematic view for explaining the operation of the regional information distribution system according to the first embodiment while FIG. 4 is a flow chart for explaining the operation thereof.

As illustrated in FIG. 4, at first, the retail shop 10 enters into a contract with the service provider 11, so that the service provider 11 issues an user's ID for the retail shop 10 (Step B1). The retail shop 10 rents the information input terminal 1 with fee (Step B2). When a request for distributing the advertisement is generated in the retail shop 10, a staff of the retail shop 10 carries out fabrication operation of the advertising data by the use of the information input terminal 1 (Step B3). The information input terminal 1 is capable of fabricating the advertising data by an easy user interface similar to that used for fabricating a home page. In addition, a template for fabricating the advertising data is supplied on a display of the information input terminal 1 from the service provider 11 The staff of the retail shop 10, who has fabricated the advertising data, designates region, date/time, period, and preferences of distribution with respect to the fabricated advertising data.

In the regional information distribution system according to the first embodiment of the present invention, a service area of a small region covered by the radio base stations 5 and 6 can be designated as a distribution region. It is therefore possible to minutely designate areas to which the advertising data are distributed. It is also possible to designate the areas not only by names of the places but also by buildings or stations in the region as conditions, such as “only areas where convenient stores are located” or “only areas where bus stops are located”. These relations between the distribution region and such information of the buildings or the stations are stored in the concentrated management server 7 as a database. It is further possible to select only areas which have previously been accessed many times. These distribution regions can be designated by GUT(Graphical User Interface) of the information input terminal 1. Data of the distribution regions are combined with map information. The data of the distribution regions combined with the map information are downloaded from the concentrated management server 7, every time the data of the distribution regions are renewed.

Besides, designation of date and time of distribution is to designate date and time when the distribution of the advertising data is started. On the other hand, designation of period of distribution is to designate a specific period or a day of the week when the advertising data are distributed.

The information input terminal 1 is capable of storing determined distribution conditions on a memory as a file. On the other hand, the information input terminal 1 is also capable of accessing the stored distribution conditions from the memory by one-touch, when the stored distribution conditions are to be used.

The advertising data to which the distribution conditions are added are transferred to the concentrated management server 7 through the communication network 2 (Step B4). The concentrated management server 7 confirms the user's ID of the retail shop 10 added to the received advertising data (Step B5). The concentrated management server 7 thereafter divides the advertising data into categories. Further, the concentrated management server 7 decides a registration fee based on the distribution conditions of the advertising data designated by the retail shop 10. The categories of the advertising data are prepared to be a menu in the handy terminals 8 and 9 of the consumers 12. For example, the categories of the advertising data are classified into “information of restaurants”, “information of low prices sales at a supermarket”, and the like. Thereafter, the advertising data are stored on the concentrated management server 7 until the designated date and time of distribution. The advertising data are transferred to the regional distribution servers 3 and 4 located in the designated distribution region before the designated date and time of distribution (Step B6). For example, when the designated distribution region is only A-1, the advertising data are transferred only to the regional distribution server 3. On the other hand, when the designated distribution regions are A-1 and A-2, the advertising data are transferred to both the regional distribution servers 3 and 4. Besides, distribution period, distribution priorities, categories distinction are timing information to distribute the advertising data for the regional distribution servers 3 and 4. These informations are added to the transferred advertising data. The regional distribution servers 3 and 4 distribute the advertising data based on the distribution period, the distribution priorities, and the category distinction added thereto. The distribution priorities are such values as indicating which data should be distributed prior to others, when other data have already been stored in the concentrated management server 7. The advertising data having higher distribution priority is distributed prior to others. The handy terminals 8, 9 positioned within the areas of the radio base stations 5, 6 acquire the advertising data stored in the regional distribution servers 3, 4, respectively, by two methods. In one of the two methods, the regional distribution servers 3 and 4 serve as triggers to distribute the advertising data to the handy terminals 8 and 9, so that the handy terminals 8 and 9 acquire the advertising data. In another one of the two methods, the handy terminals 8 and 9 serve as triggers to make the regional distribution servers 3 and 4 be accessed by the handy terminals 8 and 9, so that the handy terminals 8 and 9 acquire the advertising data.

The advertising data are classified into the above-mentioned categories to be stored in the handy terminals 8 and 9. Two methods of displaying the advertising data are prepared in the handy terminals 8 and 9. In one of the two methods, the advertising data are displayed by a list. In another one of the two methods, the advertising data are displayed by a window's pop-up. The consumers 12 can change the two methods to each other by selecting one of the two methods in the handy terminals 8 and 9. The consumers 12 who own the handy terminals 8 and 9 can watch the distributed advertising data, such as low price sales at the retail shop 10, or the like, for nothing.

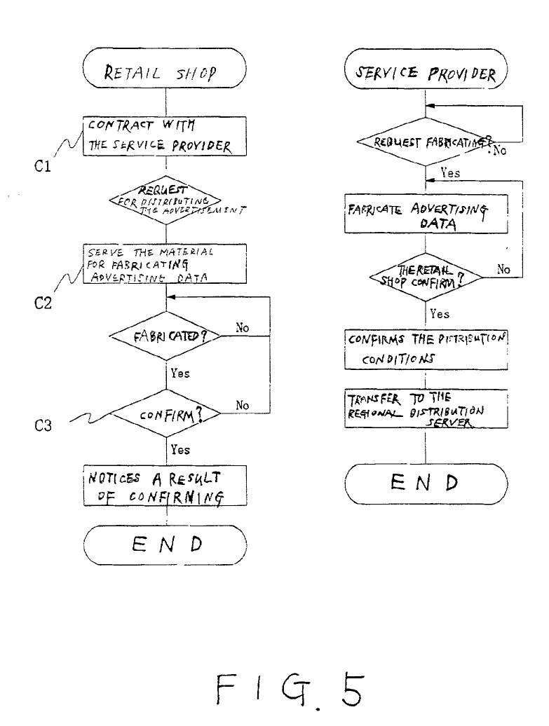

Next, referring to FIG. 5, description will proceed to a regional information distribution system according to a second embodiment of the present invention. FIG. 5 is a flow chart for explaining an operation of the regional information distribution system according to the second embodiment of the present invention.

As illustrated in FIG. 5, at first, the retail shop 10 enters into a contract with the service provider 11 (Step C1). Herein, differently from the regional information distribution system according to the first embodiment of the present invention, the information input terminal 1 is not rented to the retail shop 10 but is prepared on the service provider 11. When a request for distributing the advertisement is generated in the retail shop 10, materials for fabricating advertising data, such as data of names of articles, prices, photos, or the like, are transferred to a special purpose server of the service provider 11 (Step C2). The retail shop 10 then requests the service provider 11 to fabricate the advertising data. The requested service provider 11 fabricates the advertising data by the use of the information input terminal 1. After finishing the fabrication of the advertising data, the service provider 11 sends the fabricated advertising data to the retail shop 10. The service provider 11 requires the retail shop 10 to confirm contents of the fabricated advertising data (Step C3). Upon confirming the contents of the fabricated advertising data, the retail shop 10 notices a result of confirming the contents thereof to the service provider 11. The service provider 11 transfers the advertising data to the regional distribution servers 3 and 4. The service provider 11 charges fabrication service fee with the retail shop 10 dependent on a quantity of the fabricated advertising data. Thereafter, a sequence similar to that of the first embodiment is carried out also in this second embodiment of the present invention.

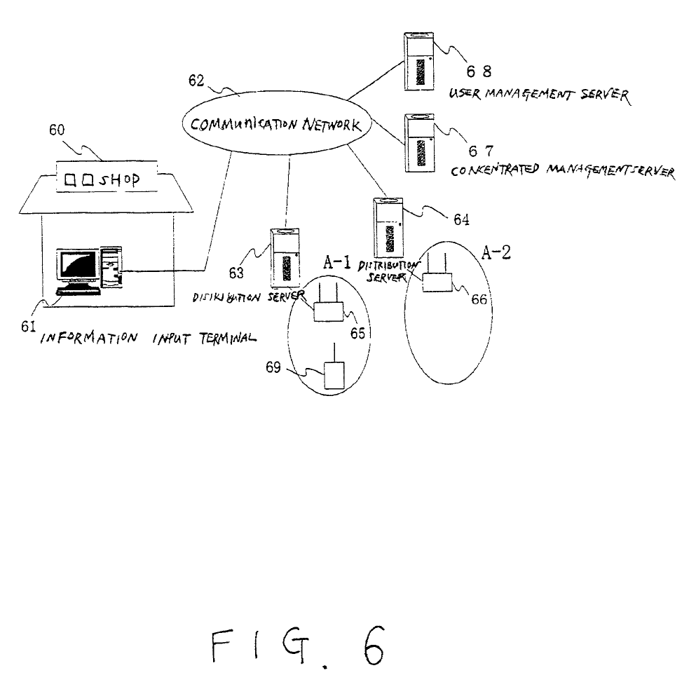

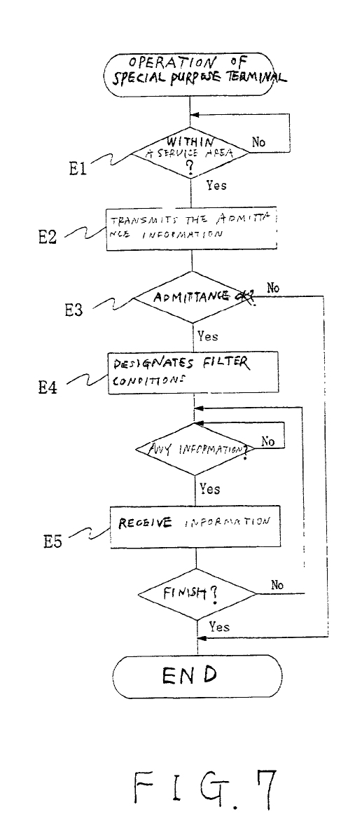

Next, referring to FIGS. 6 and 7, description will proceed to a regional information distribution system according to a third embodiment of the present invention. FIG. 6 is a schematic view for showing a constitution of the regional information distribution system according to the third embodiment of the present invention.

As illustrated in FIG. 6, the regional information distribution system according to the third embodiment of the present invention comprises an information input terminal 61, a communication network 62, radio base stations 65 and 66, and a concentrated management server 67. These are similar to those of the regional information distribution system according to the first embodiment of the present invention.

A special purpose handy terminal 69 is such a terminal as used only for this service and has both a server admittance function and an information filter function. It is the server admittance function that the special purpose handy terminal 69 transmits admitted information to the regional distribution server 63 or 64 and can receive distribution of the advertising data only when the special purpose handy terminal 69 is admitted to be a member of this service by an user management server 68. It is the information filter function that the consumer 12 previously designate favorable advertising data, such as information of restaurants, traffics, theme parks, and the like, on the special purpose handy terminal 69 as information filter conditions, and that the consumer 12 can acquire only the advertising data complying with the information filter conditions.

The consumer 12 who owns the special purpose handy terminal 69 pays the member fee to the service provider 11. The service provider 11 thereby registers the consumer 12 as the member. The user management server 68 is such a server that manages personal information or admittance information of the consumer 12 of the member.

The regional distribution servers 63 and 64 distribute the advertising data based on the distribution period and the distribution priorities. The distribution priorities are such values as indicating which data should be distributed prior to others. When other data have already been stored in the concentrated management server 67. The advertising data having higher distribution priority is distributed prior to others. Further, the regional distribution servers 63 and 64 send an inquiry to the user management server 68, when the admittance information is transmitted from the special purpose handy terminal 69. If the user management server 68 admits the special purpose handy terminal 69 as the member, the regional distribution servers 63 and 64 distribute the advertising data to the special purpose handy terminal 69. Furthermore, the regional distribution servers 63 and 64 decide the advertising data to be distributed per each member, based on the information filter conditions determined by the special purpose handy terminal 69.

Now, referring to FIG. 7, description will proceed to an operation of the regional information distribution system according to the third embodiment of the present invention. In particular, an operation of the special purpose handy terminal 69 will be described in detail. FIG. 7 is a flow chart for explaining an operation of the regional information distribution system according to the third embodiment of the present invention.

At first, when the special purpose handy terminal 69 enters into a service area of the regional distribution server 63 or 64 (Step E1), the special purpose handy terminal 69 transmits the admittance information to the regional distribution server 63 or 64 (Step E2). The regional distribution server 63 or 64 inquiries the user management server 68 whether the special purpose handy terminal 69 having transmitted the admittance information is a member or not. The user management server 68 confirms whether or not the admittance information transmitted from the special purpose handy terminal 69 is corresponding to an admittance information of the consumer 12 as a member. When the admittance information transmitted from the special purpose handy terminal 69 is confirmed to be corresponding to an admittance information of a member managed by the user management server 68, the special purpose handy terminal 69 having transmitted the admittance information is judged to be a member. The user management server 68 then transmits admittance confirmation message to the special purpose handy terminal 69. When the admittance information transmitted from the special purpose handy terminal 69 is confirmed not to be corresponding to the admittance information of the member managed by the user management server 68, the special purpose handy terminal 69 having transmitted the admittance information is judged not to be a member. The user management server 68 then transmits admittance refusal message to the special purpose handy terminal 69. When the service is stopped due to nonpayment of the member fee, the user management server 68 also transmits admittance refusal message to the special purpose handy terminal 69 (Step E3).

An owner of the special purpose handy terminal 69 admitted to be the member designates favorable information filter conditions to the special purpose handy terminal 69. The owner of the special purpose handy terminal 69 then transmits the favorable information filter conditions to the user management server 68 by the special purpose handy terminal 69 (Step E4). The user management server 68 registers the information filter conditions transmitted from the special purpose handy terminal 69. The user management server 68 then sends the information filter conditions per each member to each regional distribution server 63 or 64. The special purpose handy terminal 69 waits for information to be distributed. When the regional distribution server 63 or 64 receives the advertising data from the concentrated management server 67, the regional distribution server 63 or 64 distributes the advertising data to the special purpose handy terminal 69 based on the information filter conditions per each member (Step E5).

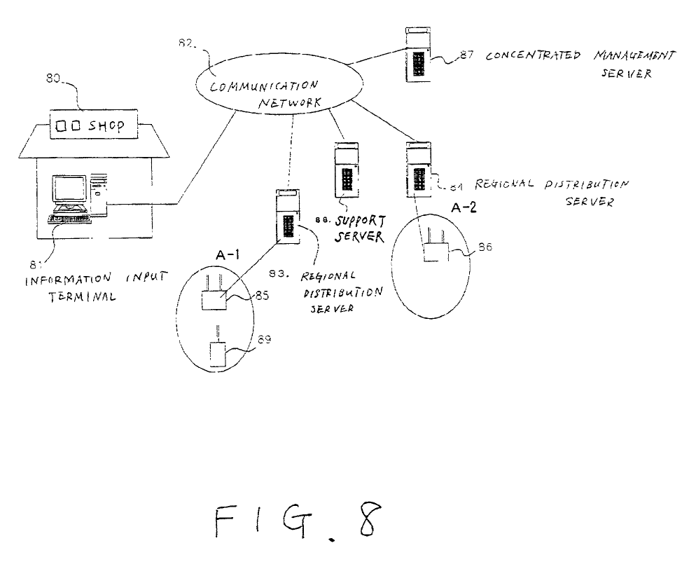

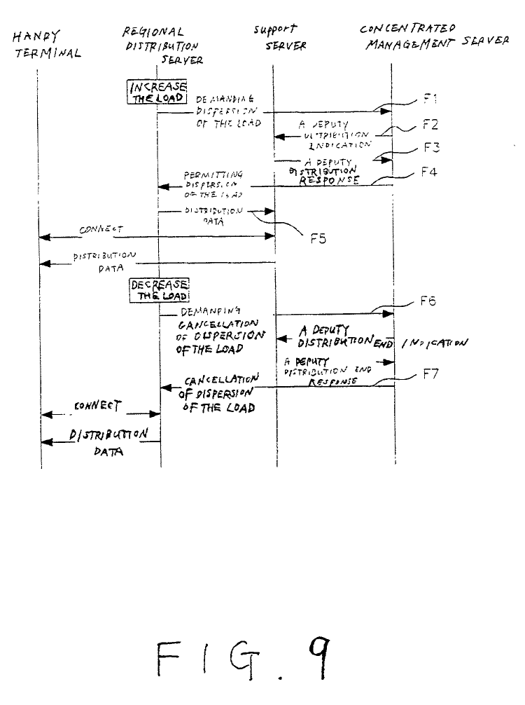

Next, referring to FIGS. 8 and 9, description will proceed to a regional information distribution system according to a fourth embodiment of the present invention. FIG. 8 is a schematic view for showing a constitution of the regional information distribution system according to the fourth embodiment of the present invention.

As illustrated in FIG. 8, the regional information distribution system according to the fourth embodiment of the present invention comprises an information input terminal 81, a communication network 82, radio base stations 85 and 86, a concentrated management server 87, and a handy terminal 89. These are similar to those of the regional information distribution system according to the third embodiment of the present invention.

The regional distribution servers 83 and 84 is such a server as storing information to be distributed in the region, similarly to the regional distribution servers 3 and 4 in the first embodiment. Further, the regional distribution servers 83 and 84 always monitor status of access from the handy terminal 89.

A support server 88 is such a server as distributing advertising data in place of the regional distribution server 83 or 84, when load of the regional distribution server 83 or 84 becomes heavy due to increase of the access from the handy terminal 89. The support server 88 is connected to the communication network 82 by a radio channel.

Now, referring to FIG. 9, description will proceed to an operation of the regional information distribution system according to the fourth embodiment of the present invention. FIG. 9 is a schematic view for explaining the operation of the regional information distribution system according to the fourth embodiment of the present invention.

When load (Occupation ratio of processing of CPU)of the regional distribution server 83 within A-1 region exceeds a certain level due to increase of the access to the regional distribution server 83, the regional distribution server 83 transmits a message of demanding dispersion of the load to the concentrated management server 87 (Step F1). The concentrated management server 87 having received the message of demanding dispersion of the load sends a deputy distribution indication message to the support server 88 (Step F2). The support server 88 sends a deputy distribution response message to the concentrated management server 87 and accepts the deputy distribution, if load of the support server 88 does not exceed a certain level (Step F3). The concentrated management server 87 having received the deputy distribution response message from the support server 88 transmits a message of permitting dispersion of the load to the regional distribution server 83 (Step F4). The regional distribution server 83 having received the message of permitting dispersion of the load from the concentrated management server 87 immediately transmits the advertising data stored by the regional distribution server 83 itself to the support server 88 (Step F5). When transmission of the advertising data is finished, distribution processing of the advertising data with respect to the handy terminals 89 accessing thereafter is carried out by the support server 88. While the support server 88 is used, the concentrated management server 87 sometimes receives new advertising data which should be distributed by the regional distribution server 83. In these cases, the concentrated management server 87 transfers the new advertising data to the support server 88. On the other hand, while the support server 88 is used, load of the regional distribution server 83 sometimes becomes lower than the certain level. In these cases, the regional distribution server 83 sends a message of demanding cancellation of dispersion of the load to the concentrated management server 87 (Step F6). Upon receiving the message of demanding cancellation of dispersion of the load from the regional distribution server 83, the concentrated management server 87 transmits a deputy distribution end message to the support server 88. The concentrated management server 87 cancel transmission of the advertising data received thereafter to the support server 88 (Step F7).

As described above, according to the regional information distribution system of the embodiments of the present invention, the following advantageous effects can be obtained.

Through a communication network, the fabricated advertising data are transmitted to the regional distribution server integrated with a radio base station located in per each region where the fabricated advertising data are distributed. Accordingly, it becomes possible for a retail shop, or the like to immediately distribute real-time information, such as time-services, and the like to a consumer who has a handy terminal, such as a handy phone.

Further, the distribution networks are divided into each distribution network in each region and has an exclusive regional distribution server, respectively. Moreover, distribution conditions, such as a region, date and time, a period, and the like are added to the advertising data to be transmitted. Accordingly, it becomes possible for a retail shop, or the like to distribute advertising data complying with distribution conditions favorable to the retail shop, or the like.

While the present invention has thus far been described in conjunction with only several embodiments thereof, it will be readily understood for those skilled in the art to put the present invention into various other manners.

For example, the handy terminal is not restricted to a handy phone. The handy terminal may be a handy-type personal computer capable of a radio communication, or a mobile computing apparatus capable of the radio communication.

Further, the communication network is not restricted to PHS(Personal Handy-phone System). The communication network may be IMT2000 or a radio LAN(Local Area Network).

What is claimed is:

1. A regional information distribution system for use in distributing regional information to consumers through a communication network, said system comprising:
an information input terminal for making advertising data designating regions where said advertising data are distributed;
a concentrated management server which is connected with said information input terminal through said communication network and which manages said advertising data; and
a regional distribution server which is connected with said concentrated management server through said communication network and which is integrated with a radio base station located per each region where said advertising data are distributed and which distributes said advertising data to a handy terminal existing within the area of said radio base station.

2. A regional information distribution system as claimed in claim 1, wherein date, time, and period for distributing said advertising data are added to said advertising data.

3. A regional information distribution system as claimed in claim 1, wherein said information input terminal is located in a shop which requests distribution of said advertising data.

4. A regional information distribution system as claimed in claim 2, wherein said information input terminal is located in a shop which requests distribution of said advertising data.

5. A regional information distribution system as claimed in claim 4, wherein information of position of said shop is linked to said regional distribution server.

6. A regional information distribution system as claimed in claim 1, wherein said handy terminal has information filter function for determining favorable conditions of said advertising data for an owner of said handy terminal.

7. A regional information distribution system as claimed in claim 6, wherein said regional distribution server distributes only a part of said advertising data to said handy terminal; said part of said advertising data complying with said favorable conditions determined by said information filter function.

8. A regional information distribution system as claimed in claim 1, further comprising a support server for distributing said advertising data in place of said regional distribution server, when load is concentrated on said regional distribution server.

9. A method of distributing regional information for use in distributing regional information to consumers through a communication network, said method comprising the steps of:
making advertising data including designated regions where said advertising data are distributed;
transmitting said advertising data to a concentrated management server through said communication network;
transmitting said advertising data to a regional distribution server which is located within said designated regions where said advertising data are distributed;
and
distributing said advertising data to a handy terminal existing within an area of a radio base station integrated with said regional distribution server.

10. A method of distributing regional information as claimed in claim 9, wherein date, time, and period for distributing said advertising data are added to said advertising data.

11. A method of distributing regional information as claimed in claim 10, wherein said advertising data are made in a shop which requests distribution of said advertising data.

12. A method of distributing regional information as claimed in claim 11, wherein information of position of said shop is linked to said regional distribution server.

13. A method of distributing regional information as claimed in claim 12, further comprising the steps of: determining favorable conditions of said advertising data by said handy terminal for an owner of said handy terminal; and distributing only a part of said advertising data to said handy terminal, said part of said advertising data complying with said favorable conditions.

14. A method of distributing regional information as claimed in claim 13, further comprising the steps of: distributing said advertising data by a support server in place of said regional distribution server, when load is concentrated on said regional distribution server.
